(19) United States
(12) Patent Application Publication
(10) Pub. No.: US 2013/0100034 A1
(43) Pub. Date: Apr. 25, 2013

(54) Mobile Device with Concave Shaped Back Side

(71) Applicants: Matthew Nicholas Papakipos, Palo Alto, CA (US); Matthew Cahill, San Francisco, CA (US)

(72) Inventors: Matthew Nicholas Papakipos, Palo Alto, CA (US); Matthew Cahill, San Francisco, CA (US)

(21) Appl. No.: 13/276,458

(22) Filed: Oct. 19, 2011

(51) Int. Cl. G06F 3/041

(52) U.S. Cl. 345/173

(57) ABSTRACT

In one embodiment, a mobile device comprises a display disposed on the mobile device's front side and a touch surface disposed on the mobile device's concavely-shaped back side.

### TECHNICAL FIELD

The present disclosure relates generally to mobile devices, and, more particularly, to a mobile device with a display disposed on the mobile device's front side and a touch surface disposed on the mobile device's concavely-shaped back side.

### BACKGROUND

A touchpad is an input device including a surface that detects touch-based inputs of users. A touch screen is an electronic visual display that detects the presence and location of user touch inputs. Mobile devices such as a mobile phone, a tablet computer, and a laptop computer often incorporate a touch screen or a touchpad to facilitate user interactions with application programs running on the mobile device.

### SUMMARY

Particular embodiments relate to a mobile device with a display disposed on the mobile device's front side and a touch surface disposed on the mobile device's concavely-shaped back side. The concavely-shaped back side may protect the touch surface from accidental activations and abrasions. These and other features, aspects, and advantages of the disclosure are described in more detail below in the detailed description and in conjunction with the following figures.

### BRIEF DESCRIPTION OF THE DRAWINGS

FIG. 1, 2, 2A, and 2B illustrate example mobile devices with a back side comprising a concavely-shaped region.

FIG. 3 illustrates an example proximity sensor located on the back side of the example mobile device of FIG. 1.

FIG. 4 illustrates an example mobile device platform.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A touchpad is an input device including a surface that detects touch-based inputs of users. Similarly, a touch screen is an electronic visual display surface that detects the presence and location of user touch inputs. So-called dual touch or multi-touch displays or touchpads refer to devices that can identify the presence, location and movement of more than one touch input, such as two or three finger touches. A system incorporating one or more touch-based input devices may monitor one or more touch-sensitive surfaces for one or more touch or near touch inputs from a user. When one or more such user inputs occur, the system may determine the distinct area(s) of contact and identify the nature of the touch or near touch input(s) via geometric features and geometric arrangements (e.g., location, movement), and determine if they correspond to various touch events (e.g., tap, drag, swipe, pinch). For example, the system may comprise one or more device drivers communicating with the one or more touch-based input devices and detecting touch inputs. The system may comprise a touch event library containing codes that interpreting touch inputs detected by the device drivers to touch events or gestures. A program running on the system can process touch events by subscribing as listeners to touch event functions in the touch event library.

Particular embodiments herein relate to a mobile device (e.g., a mobile phone, a smart phone, a tablet, or other portable device) with a display disposed on a front side of the device and a touch surface disposed on a back side of the device. The back-side touch surface can improve user experience associated with the mobile device as the back-side touch surface can provide an additional area for user inputs. However, the back-side touch surface may be prone to unintentional activations (e.g., by a user's fingers as the user holds the mobile device in his hand) or abrasions (e.g., by a foreign object on a table when a user places the mobile device on the table). Particular embodiments herein describe a mobile device with a back-side touch surface that situated within a concavely-shaped region of the back side of the mobile device, thus reducing unintentional activations or abrasions.

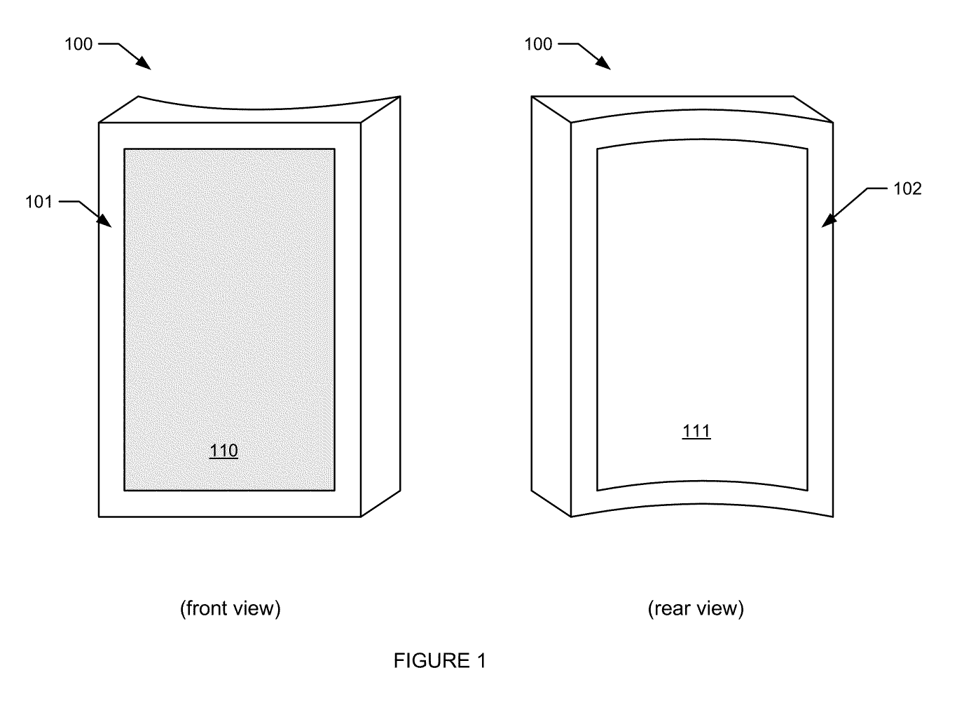

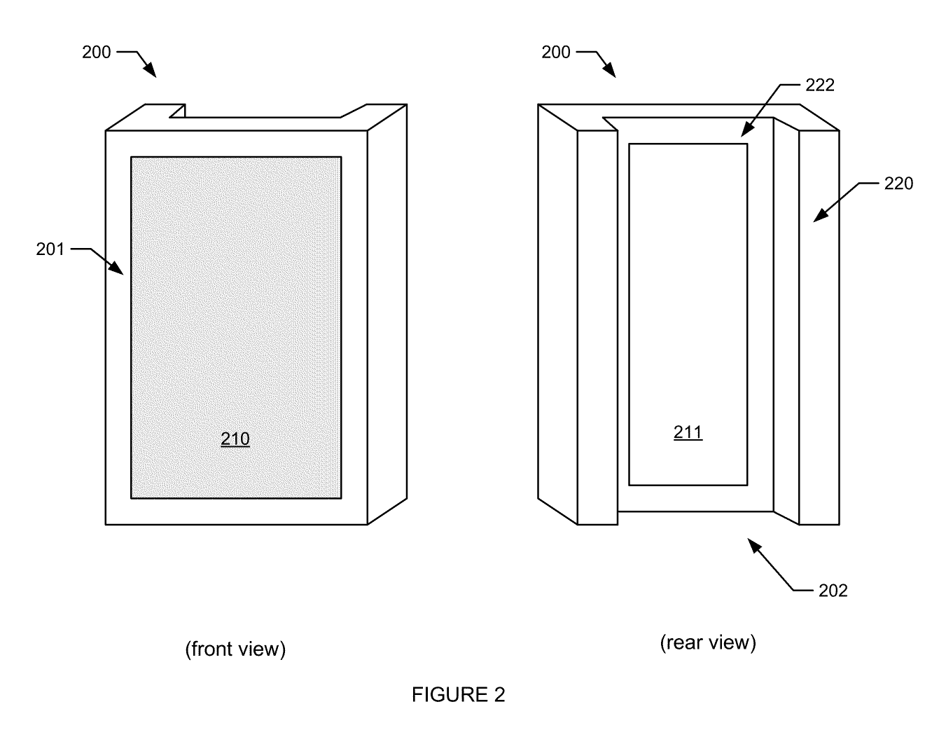

FIG. 1 illustrates an example mobile device with a back side comprising a concavely-shaped region. In particular embodiment, mobile device 100 may comprise a device housing with front side 101 and back side 102, wherein back side 102 comprising a curved, concavely-shaped region. In particular embodiments, mobile device 100 may comprise display 110 disposed on front side 101. In some embodiments, display 110 may comprise a touch sensitive (e.g., multi-touch) display. In particular embodiments, mobile device 100 may comprise touch surface 111 within the curved concavely-shaped region of back side 102. Touch surface 111 may be a single- or multi-touch device. In some embodiments, touch surface 111 may comprise a touch display. In some embodiments, touch surface 111 may comprise a surface texture different from rest of the device housing—e.g., a different texture may enable tactile feedback to a user to distinguish between touch surface 111 and rest of device housing. In some embodiments, touch surface 111 may comprise a surface conformal to the curved concavely-shaped region of back side 102. In other embodiments, touch surface 111 may comprise a surface not conformal to the curved concavely-shaped region of back side 102 (e.g., touch surface 111 may comprise a flat surface). In the example of FIG. 1, the curved concavely-shaped region of back side 102 may provide a user a tactile impression of the device orientation (i.e., to distinguish between back side 102 and front side 101), and may protect touch surface 111 from accidental activations or abrasions.

FIG. 2 illustrates another example mobile device with a back side comprising a concavely-shaped region. In particular embodiments, mobile device 200 may comprise a device housing with front side 201 and back side 202, wherein back side 202 may comprise an edge region 220 and a hollow or offset region 222 offset from edge region 220 in a direction toward the device housing's center. In particular embodiments, mobile device 200 may comprise display 210 disposed on front side 201. In some embodiments, display 210 may comprise a touch display. In particular embodiments, mobile device 200 may comprise touch surface 211 within offset region 222. Touch surface 211 may be a single- or multi-touch device. In some embodiments, touch surface 211 may comprise a touch display. In some embodiments, touch surface 211 may comprise a surface texture different from rest of the device housing—e.g., a different texture may enable tactile feedback to a user to distinguish between touch surface 111 and rest of device housing. In some embodiments, offset region may comprise a flat surface, as illustrated in FIG. 2. In other embodiments, offset region 222 may comprise a curved concavely-shaped surface, as illustrated in FIG. 2A. In some embodiments, edge area 220 may comprise more than two edges of mobile device 200, as illustrates in FIG. 2B. In some embodiments, touch surface 211 may comprise a surface conformal to offset region 222. In other embodiments, touch surface 211 may comprise a surface not conformal to offset region 222. For example, a flat touch surface 211 may be situated within a curved concavely-shaped offset region 222. For example, a curvedly-shaped touch surface 211 may be situated within a flat offset region 222. In the examples of FIGS. 2, 2A, and 2B, edge area 220 and/or offset area 222 may provide a user a tactile impression of the device orientation (i.e., to distinguish between back side 102 and front side 101), and may protect touch surface 211 situated within offset region 222 from accidental activations or abrasions.

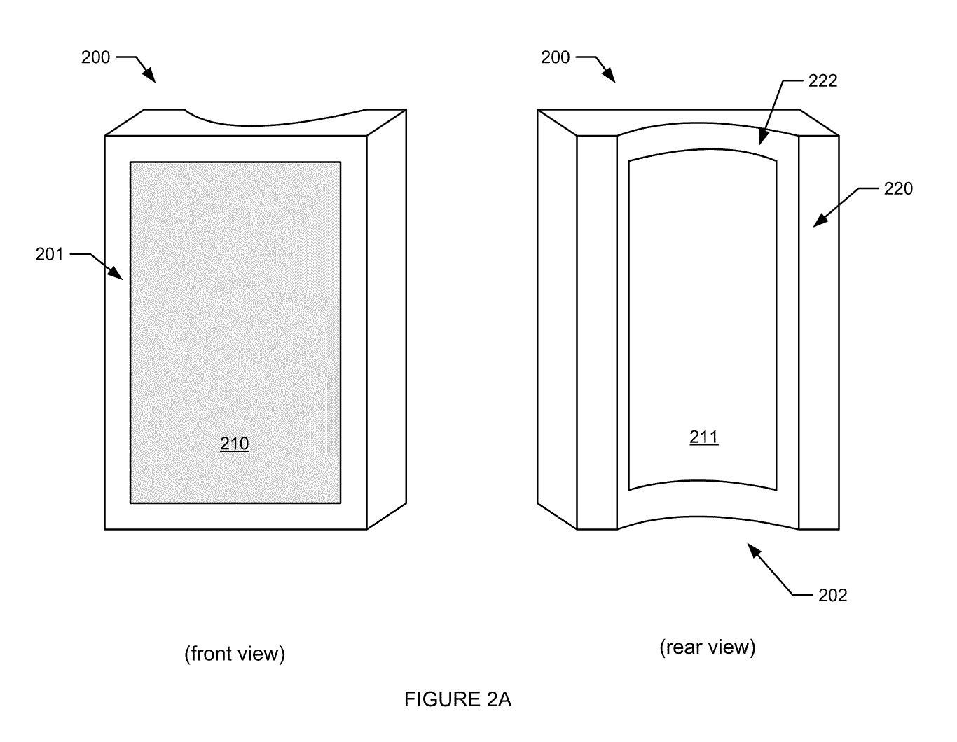

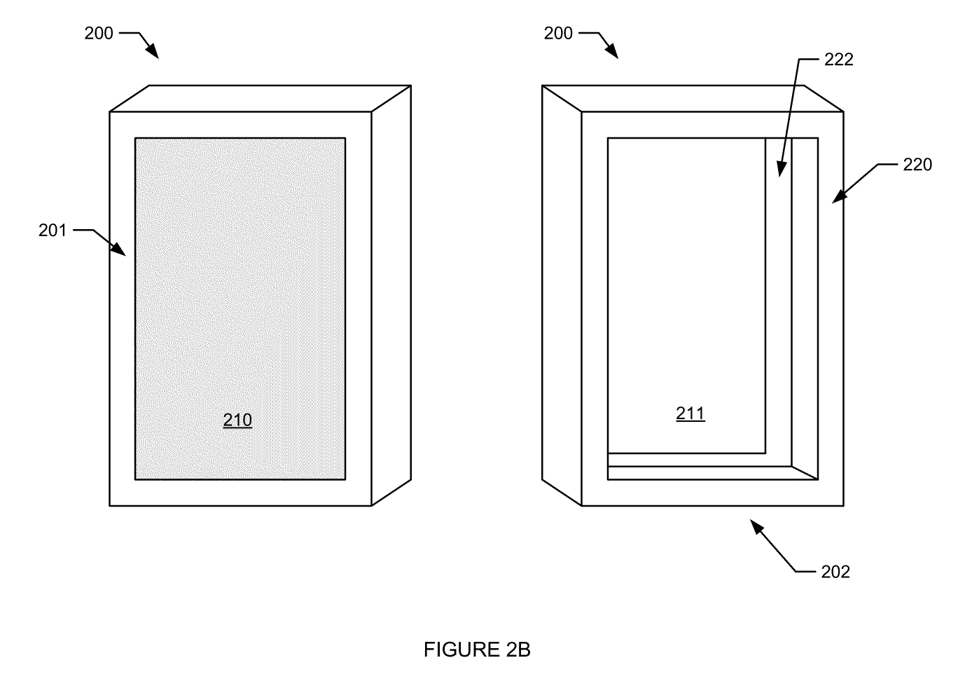

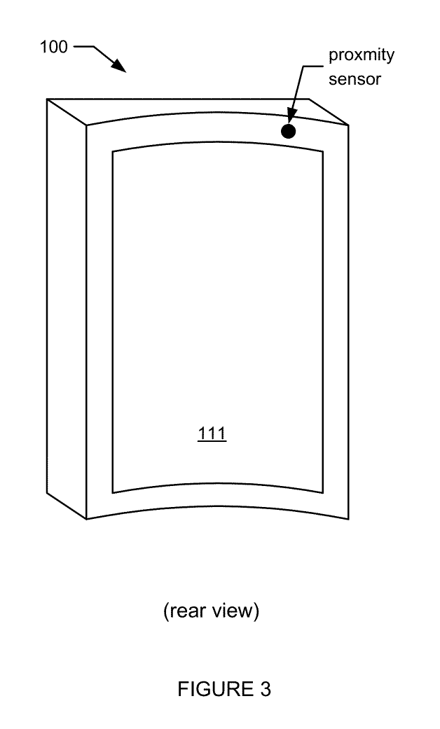

In particular embodiments, a mobile device (e.g., a mobile phone, a smart phone, a tablet, or other portable device) with a front side comprising a display and a back side comprising a touch surface (e.g., a touchpad, a touch screen) may comprise a light sensor or a proximity sensor on the back side of the mobile device. FIG. 3 illustrates an example proximity sensor located on the back side of mobile device 100 of the example of FIG. 1. In particular embodiments, a process or thread hosted by one or more processors of the mobile device may access a back-side light sensor (e.g., via a function call) and determines a dark or almost dark surrounding, the process may transition or cause to transition the back-side touch surface to a lower power state (e.g., turning off a back-side touch screen). In particular embodiments, a process or thread hosted by one or more processors of the mobile device may access a back-side proximity sensor (e.g., via a function call) and determine presence of a nearby object (e.g., the side facing down), the process may transition or cause to transition the back-side touch surface to a lower power state (e.g., turning off a back-side touchpad).

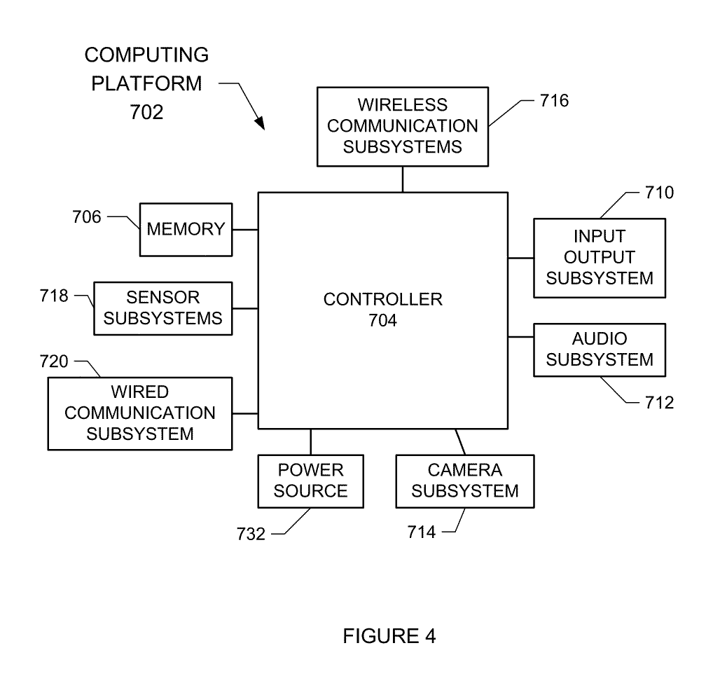

While the mobile device may be implemented in a variety of different hardware and computing systems, FIG. 4 shows a schematic representation of the main components of an example computing platform of a client or mobile device, according to various particular embodiments. In particular embodiments, computing platform 702 may comprise controller 704, memory 706, and input output subsystem 710. In particular embodiments, controller 704 which may comprise one or more processors and/or one or more microcontrollers configured to execute instructions and to carry out operations associated with a computing platform. In various embodiments, controller 704 may be implemented as a single-chip, multiple chips and/or other electrical components including one or more integrated circuits and printed circuit boards. Controller 704 may optionally contain a cache memory unit for temporary local storage of instructions, data, or computer addresses. By way of example, using instructions retrieved from memory, controller 704 may control the reception and manipulation of input and output data between components of computing platform 702. By way of example, controller 704 may include one or more processors or one or more controllers dedicated for certain processing tasks of computing platform 702, for example, for 2D/3D graphics processing, image processing, or video processing.

Controller 704 together with a suitable operating system may operate to execute instructions in the form of computer code and produce and use data. By way of example and not by way of limitation, the operating system may be Windows-based, Mac-based, Unix Linux-based, Android-based, or Symbian-based, among other suitable operating systems. The operating system, other computer code and/or data may be physically stored within memory 706 that is operatively coupled to controller 704.

Memory 706 may encompass one or more storage media and generally provide a place to store computer code (e.g., software and/or firmware) and data that are used by computing platform 702. By way of example, memory 706 may include various tangible computer-readable storage media including Read-Only Memory (ROM) and/or Random-Access Memory (RAM). As is well known in the art, ROM acts to transfer data and instructions uni-directionally to controller 704, and RAM is used typically to transfer data and instructions in a bi-directional manner. Memory 706 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to controller 704. Information may also reside on one or more removable storage media loaded into or installed in computing platform 702 when needed. By way of example, any of a number of suitable memory cards (e.g., SD cards) may be loaded into computing platform 702 on a temporary or permanent basis.

Input output subsystem 710 may comprise one or more input and output devices operably connected to controller 704. For example, input output subsystem may include keyboard, mouse, one or more buttons, thumb wheel, and/or, display (e.g., liquid crystal display (LCD), light emitting diode (LED), Interferometric modulator display (IMOD), or any other suitable display technology). Generally, input devices are configured to transfer data, commands and responses from the outside world into computing platform 702. The display is generally configured to display a graphical user interface (GUI) that provides an easy to use visual interface between a user of the computing platform 702 and the operating system or application(s) running on the mobile device. Generally, the GUI presents programs, files and operational options with graphical images. During operation, the user may select and activate various graphical images displayed on the display in order to initiate functions and tasks associated therewith. Input output subsystem 710 may also include touch based devices such as touch pad and touch screen. A touchpad is an input device including a surface that detects touch-based inputs of users. Similarly, a touch screen is a display that detects the presence and location of user touch inputs. Input output system 710 may also include dual touch or multi-touch displays or touch pads that can identify the presence, location and movement of more than one touch inputs, such as two or three finger touches.

In particular embodiments, computing platform 702 may additionally comprise audio subsystem 712, camera subsystem 712, wireless communication subsystem 716, sensor subsystems 718, and/or wired communication subsystem 720, operably connected to controller 704 to facilitate various functions of computing platform 702. For example, Audio subsystem 712, including a speaker, a microphone, and a codec module configured to process audio signals, can be utilized to facilitate voice-enabled functions, such as voice recognition, voice replication, digital recording, and telephony functions. For example, camera subsystem 712, including an optical sensor (e.g., a charged coupled device (CCD), or a complementary metal-oxide semiconductor (CMOS) image sensor), can be utilized to facilitate camera functions, such as recording photographs and video clips. For example, wired communication subsystem 720 can include a Universal Serial Bus (USB) port for file transferring, or a Ethernet port for connection to a local area network (LAN). Additionally, computing platform 702 may be powered by power source 732.

Wireless communication subsystem 716 can be designed to operate over one or more wireless networks, for example, a wireless PAN (WPAN) (such as, for example, a BLUETOOTH WPAN, an infrared PAN), a WI-FI network (such as, for example, an 802.11 a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network).

Sensor subsystem 718 may include one or more sensor devices to provide additional input and facilitate multiple functionalities of computing platform 702. For example, sensor subsystems 718 may include GPS sensor for location positioning, altimeter for altitude positioning, motion sensor for determining orientation of a mobile device, light sensor for photographing function with camera subsystem 714, temperature sensor for measuring ambient temperature, and/or biometric sensor for security application (e.g., fingerprint reader). Other input/output devices may include an accelerometer that can be used to detect the orientation of the device. In particular embodiments, various components of computing platform 702 may be operably connected together by one or more buses (including hardware and/or software). Additionally, computing platform 702 may be powered by power source 732.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a MultiMediaCard (MMC) card, an embedded MMC (eMMC) card, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. An apparatus comprising:
a device housing having a front side and a back side, wherein the back side has a concavely-shaped region;
a memory;
one or more processors;
a display disposed on the front side of the device housing; and
a touch surface disposed on the back side of the device housing within the concavely-shaped region.

2. The apparatus of claim 1, wherein the touch surface comprises a touch display.

3. The apparatus of claim 1, wherein the concavely-shaped region comprises a curved concave surface.

4. The apparatus of claim 1, wherein the concavely-shaped region comprises the touch surface and an edge area of the back side, the touch surface being offset from the edge area in an direction toward the device housing's center.

5. The apparatus of claim 1, further comprising a light sensor disposed on the back side of the device housing.

6. The apparatus of claim 1, further comprising a proximity sensor disposed on the back side of the device housing.
